(19) United States
(12) Patent Application Publication
(10) Pub. No.: US 2011/0185084 A1
(43) Pub. Date: Jul. 28, 2011

(54) INFORMATION COMMUNICATION SYSTEM, RELAY NODE DEVICE, INFORMATION COMMUNICATION METHOD, AND COMPUTER READABLE RECORDING MEDIUM

(75) Inventor: KAZUHIRO NAKAMURA, Nagoya-shi (JP)

(73) Assignee: BROTHER KOGYO KABUSHIKI KAISHA, Aichi-ken (JP)

(21) Appl. No.: 13/010,350

(22) Filed: Jan. 20, 2011

(30) Foreign Application Priority Data
Jan. 27, 2010 (JP) 2010-015962

(51) Int. Cl. G06F 15/16

(52) U.S. Cl. 709/245

(57) ABSTRACT

An information communication system including, among a plurality of node devices, a relay node device which is connected to a private network and which relays the messages between the private network and an external network differing from the private network, wherein the relay node device comprising relay unit configured to relay the message after causing the global address information acquired by the acquisition unit to be contained in the message in response to relaying the message from the private network to the external network, and to relay the message after causing the private address information acquired by the acquisition unit to be contained in the message in response to relaying the message from the external network to the private network which is connected to the external network.

### BACKGROUND OF THE INVENTION

1. Field of the Invention

The present invention relates to a technical field of a communication system of the Peer to Peer (P2P) type including a plurality of node devices that can communicate with one another via a network.

2. Description of the Related Art

Recently, attention has been focused on a communication system of the Peer to Peer type. The communication system of the Peer to Peer type is focused as a new style to be substituted for the client and server type that is currently a primary style in the field of content delivery (distribution). In the communication system of the Peer to Peer type, a communication load is distributed to a plurality of node devices. Therefore, the communication system of the Peer to Peer type can perform more efficient communication than the client and server type.

In some cases, the node devices participating in the communication system of the Peer to Peer type are connected to a network having a private address space, such as a LAN (Local Area Network). In that case, the so-called NAT (Network Address Translation) traversal is required to allow one node device to communicate with another node device outside the LAN in the Peer to Peer mode. For the NAT traversal, a dedicated server is required which executes, for example, an address resolution such that the node device can acquire the global address and the port number thereof.

With the provision of the dedicated server, however, accesses for the address resolution are extremely concentrated on the dedicated server as the number of node devices increases. Consequently, the effect expected by employing the communication system of the Peer to Peer type cannot be sufficiently obtained.

### SUMMARY OF THE INVENTION

The present invention has been accomplished in view of the problem described above. An object of the present invention is to provide an information communication system, a relay node device, an information communication method, computer readable recording medium etc., which can reduce a processing load required for the address resolution when node devices connected to different networks communicate with each other.

According to the present invention, there is provided an information communication system in which a plurality of node devices transmit and receive messages with respect to one another via a network including at least one private network, the information communication system including, among the plurality of node devices, a relay node device which is connected to the private network and which relays the messages between the private network and an external network differing from the private network, wherein the relay node device comprising an acquisition unit configured to acquire, as address information of the relay node device, private address information representing address information in the private network and global address information representing address information in the external network, and a relay unit configured to relay the message after causing the global address information acquired by the acquisition unit to be contained in the message in response to relaying the message from the private network to the external network, and to relay the message after causing the private address information acquired by the acquisition unit to be contained in the message in response to relaying the message from the external network to the private network which is connected to the external network, and wherein the node device connected to the private network comprising a transmission unit configured to transmit a message, which is destined for the node device connected to the external network, through the relay node device.

Also, there is provided a relay node device disposed in an information communication system, in which a plurality of node devices transmit and receive messages with respect to one another via a network including at least one private network, to serve as one of the node devices to relay the messages, the information communication system including, among the plurality of node devices, the relay node device which is connected to the private network and which relays the messages between the private network and an external network differing from the private network, wherein the relay node device comprising, an acquisition unit configured to acquire as address information of the relay node device, private address information representing address information in the private network and global address information representing address information in the external network, and relay unit configured to relay the message after causing the global address information acquired by the acquisition unit to be contained in the message in response to relaying the message from the private network to the external network, and to relay the message after causing the private address information acquired by the acquisition unit to be contained in the message in response to relaying the message from the external network to the private network which is connected to the external network.

Further, there is provided an information communication method for a relay node device that is disposed in an information communication system, in which a plurality of node devices transmit and receive messages with respect to one another via a network including at least one private network, to serve as one of the node devices to relay the messages, the information communication system including, among the plurality of node devices, the relay node device which is connected to the private network and which relays the messages between the private network and an external network differing from the private network, wherein the information communication method comprising acquiring, as address information of the relay node device, private address information representing address information in the private network and global address information representing address information in the external network by the relay node device; and relaying the message after causing the global address information acquired in the acquiring to be contained in the message in response to the message from the private network to the external network, and relaying the message after causing the private address information acquired in the acquisition step to be contained in the message in response to relaying the message from the external network to the private network which is connected to the external network.

Still further, there is provided a non-transitory computer readable recording medium storing a program for operating a relay node device that is disposed in an information communication system, in which a plurality of node devices transmit and receive messages with respect to one another via a network including at least one private network, to serve as one of the node devices to relay the messages, the information communication system including, among the plurality of node devices, the relay node device which is connected to the private network and which relays the messages between the private network and an external network differing from the private network, wherein the program causing a computer of the relay node device to execute, acquiring, as address information of the relay node device, private address information representing address information in the private network and global address information representing address information in the external network and relaying the message after causing the global address information acquired in the acquiring to be contained in the message in response to relaying the message from the private network to the external network, and relaying the message after causing the private address information acquired in the acquiring to be contained in the message in response to relaying the message from the external network to the private network which is connected to the external network.

### BRIEF DESCRIPTION OF THE DRAWINGS

FIG. 1 illustrates one example of a connection form of node devices in a content distributed storage system according to one embodiment;

FIG. 2 is a block diagram illustrating an example of the configuration of one node Nn;

FIG. 3 illustrates a connection example of networks and nodes Nn.

FIG. 4 is a flowchart illustrating a processing example executed by a control unit in a non-relay node according to one embodiment; and

FIGS. 5A and 53 are a flowchart illustrating a processing example executed by the control unit in a relay node according to one embodiment.

### DESCRIPTION OF THE PREFERRED EMBODIMENTS

One embodiment of the present invention will be described below with reference to the drawings. In the following embodiment, the present invention is applied to a content distributed storage system.

### [1. General Configuration of Content Distributed Storage System]

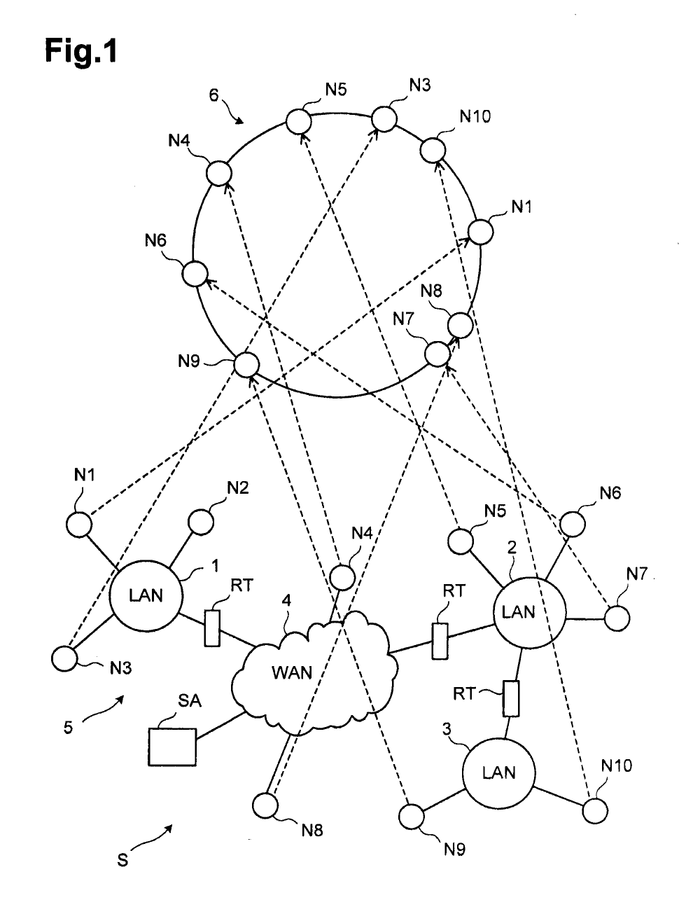

First, the general configuration of a content distributed storage system S according to one embodiment is described with reference to FIG. 1. As illustrated in FIG. 1, the content distributed storage system S is constituted by connecting plurality of node devices Nn (n=1, 2, 3, etc.) via a network 5. The network 5 is a communication network in a real world. The network 5 is, for example, the Internet. The network 5 includes a plurality of LANs, i.e., LANm (m=1, 2, 3, etc.), and a WAN (Wide Area Network) 4. Further, routers RT for interconnecting one LANm and another LANm or one LANm and the WAN 4 are inserted in the network 5. The routers RT are each, for example, a broadband router or a firewall.

Each of the node devices Nn is connected to a LANm or the WAN 4, which constitute the network 5. Hereinafter, the node device is referred to simply as a “node”. The nodes connected to the WAN 4 include, for example, a node which is solely connected to the LAN that is not connected to any other nodes, and which can perform the NAT traversal. In other words, there is a node which can transmit and receive messages to and from the outside of the LAN without intervention of a relay node (described later), and which does not require a later-described relay. The node not requiring the relay is also illustrated in FIG. 1 as the node connected to the WAN 4. Each node is assigned with a production number and an IP (Internet Protocol) address, which are specific to the relevant node. The content distributed storage system S according to this embodiment is constituted as a network system of the Peer to Peer type that is formed through connection among plural ones of the nodes in the network 5.

Such a network system of the Peer to Peer type is illustrated as a network 6 in FIG. 1. The network 6 is an overlay network constituting a virtual link that is formed by utilizing the existing network 5. The network 6 as a logical network is realized with a particular algorithm, e.g., an algorithm employing a DHT (Distributed Hash Table). Further, a node ID, i.e., specific identification (ID) information made of a predetermined number of digits, is assigned to each node connected to the content distributed storage system S.

The connection to the content distributed storage system S is established by transmitting a participation message from a node that is not yet connected to the content distributed storage system S, e.g., the node N8. The participation message is a message that indicates a request for participation into the content distributed storage system S. The participation message is transmitted from the node, which is not yet connected to the content distributed storage system S, to an arbitrary node connected thereto. Here, the term “arbitrary node” means, for example, a contact node that is always connected to the content distributed storage system S. Also, the participation into the content distributed storage system S means the fact that the node having requested the participation comes into a state connected to the content distributed storage system S and capable of acquiring content data from the content distributed storage system S. In other words, the participation into the content distributed storage system S is equivalent to participation into the overlay network 6. The participation into the overlay network 6 means the fact that the relevant node comes into a state capable of transmitting and receiving various messages with respect to other nodes via the overlay network 6 based on a routing table using the DHT. When the node receives the participation message, the received node transmits a participation response message to the node device which sent the participation message. The participation message may contain a part of the DHT routing table.

Further, each node stores the routing table using the DHT. The routing table specifies the forwarding destinations of various messages on the content distributed storage system S. More specifically, the routing table registers therein plural sets of node information including the node ID, the IP address, and the port number for each of the nodes which are appropriately spaced from one another within an ID space. The set of the IP address and the port number is called “address information”.

One of the nodes connected to the content distributed storage system S stores, as the routing table, the node information of the least necessary nodes. Through transfer of various messages among the nodes, the relevant node acquires the node information of the node whose node information is not yet stored. The routing table using the DHT is known, for example, from U.S. Patent Application Publication No. 2007/283043 A1, which is incorporated herein by reference and hence a detailed description thereof is omitted here.

The content distributed storage system S stores replicas of various content data having different contents in a predetermined file format such that the replicas are distributed to a plurality of nodes. Hereinafter, the content data is referred to simply as “content”. Thus, the replicas are utilizable among the nodes. The original of each of the contents is stored in a center server SA. Hereinafter, the node storing the replica of the content is referred to as a “content holding node”. In the following description, the original content and the replica thereof are both called “content” without drawing a distinction between them.

To each of the contents is attached information including, for example, the content name and the content ID that is ID information specific to the content. Locations of the contents stored in a distributed manner are stored as index information in, for example, a node that serves to manage or store the locations of the contents. Hereinafter, the node serving to manage or store the locations of the contents is referred to as a “root node”. The index information includes a set of the node information regarding the node that stores the replica, the content ID of the content, etc. The root node is defined, for example, as a node having the node ID that is closest to the content ID. The node ID closest to the content ID is, for example, a node ID that matches with the content ID in a larger number of higher digits.

When a user of some node wants to obtain the desired content, the node in which the user wants to obtain the desired content generates a search request message. Hereinafter, the node in which the user wants to obtain the desired content is referred to as a “user node”. The search request message includes the content ID of the content that the user wants to obtain, and the node information of the user node, etc. The search request message is a message to search for the content holding node. The search request message is transmitted to another node in accordance with the routing table using the DHT, which is stored in the user node. In other words, the user node transmits the search request message to the root node. Thus, the search request message finally reaches the root node using the DHT routing with the content ID being a key.

Attribute information of the content, such as the content name and the content ID, is described in content catalogue information. The content catalogue information is prepared by the center server SA and is delivered to all the nodes. The content ID included in the search request message may be generated by the user node such that the content name is hashed by the common hash function. The DHT routing is known, for example, from the previously mentioned U.S. Patent Application Publication No. 2007/283043 A1.

When the root node receives the search request message, the received root node acquires, from an index information cache, the index information corresponding to the content ID that is contained in the received search request message. Then, the root node transmits a content transmission request message to the content holding node that is indicated, for example, by the IP address included in the acquired index information. When the content holding node receives the content transmission request message, the received content holding node transmits, to the user node, a content transmission message including the content stored therein. As a result, the user node can download or acquire the content from the content holding node.

The root node may reply with the index information to the user node that is a transmission source of the search request message. In this case, the user node acquired the index information can download the content based on the index information. More specifically, the user node accesses the content holding node based on, e.g., the IP address of the content holding node, which is included in the index information. Then, the user node can download the content from the content holding node having been accessed. As an alternative, during a period until the search request message reaches the root node, the user node may acquire the index information from a cache node, which caches the same index information as that stored in the root node.

When the user node acquires the content from the content holding node and stores the content in itself, a publish message is generated by the user node having stored the content. The publish message is a message for notifying the root node of the fact that the content has been stored. The publish message includes the content ID of the content and the node information of the node that has stored the content. The publish message is sent to the root node. Thus, like the search request message, the publish message reaches the root node using the DHT routing with the content ID being a key. The root node then receives the publish message. The root node stores, in an index information cache area, the index information including the set of the node information and the content ID, the index information being contained in the publish message. In such a manner, the user node newly becomes a content holding node that holds the relevant content.

In the content distributed storage system S constituted as described above, the NAT traversal needs to be set in advance. With the setting of the NAT traversal, messages can be transmitted and received in the Peer to Peer mode between one node connected to one LAN and another node connected to a WAN or another LAN differing from the former LAN, to which the one node is connected. In order to allow all the nodes to make the NAT traversal, however, the rooter RT is required to hold ports open in number proportional to the number of nodes. Holding many ports open may give rise to a problem from the viewpoint of safety, for example. Also, another problem may occur in that a table for address translation based on the NAT is completely filled in the router RT and a failure is generated in communication between the networks. In view of those problems, at least one node capable of making the NAT traversal is determined for each LAN in the content distributed storage system S. Further, the node capable of making the NAT traversal relays a message from the LAN, to which the node capable of making the NAT traversal is connected, to the network other than the LAN to which the node capable of making the NAT traversal is connected. In addition, the node capable of making the NAT traversal relays at least two types of messages. One type is a message from one LAN to which the node capable of making the NAT traversal is connected, to the network other than the one LAN. The Other type is a message from the network other than one LAN to which the node capable of making the NAT traversal is connected, to the one LAN.

The node relaying the message in such a manner is called a “relay node”. Nodes other than the relay node are each called a “non-relay node”. When a certain node is regarded as a reference, the LAN to which the reference node is connected is called an “in-LAN”. A node N connected to the LAN, to which the reference node is connected, is called an “in-LAN node”. A network other than the in-LAN is called an “ex-LAN network”. Further, a node Nn connected to the network other than the in-LAN is called an “ex-LAN node”. Details of the message relay will be described later.

The following setting of the router RT is executed as the setting for the NAT traversal. For example, the setting is executed to perform port-forwarding of one port of the router RT to a port of the relay node, which has been determined in advance. On the other hand, the port-forwarding is not performed on the non-relay node. Thus, communication between the in-LAN node and the ex-LAN node may be made possible just by opening only one port for the relay node in each LAN. As the setting for the NAT traversal, the setting of the router RT may be executed, for example, by performing the port-forwarding of a predetermined number of ports of the router RT to ports of the relay node. The ports of the relay node are determined in advance. There are plural relay nodes in some cases. In such a case, the setting of the router RT may be executed, for example, by performing, for each of the relay nodes, the port-forwarding of one port of the router RT to a port of each relay node. The port of each relay node is determined in advance.

### [2. Configuration of Node]

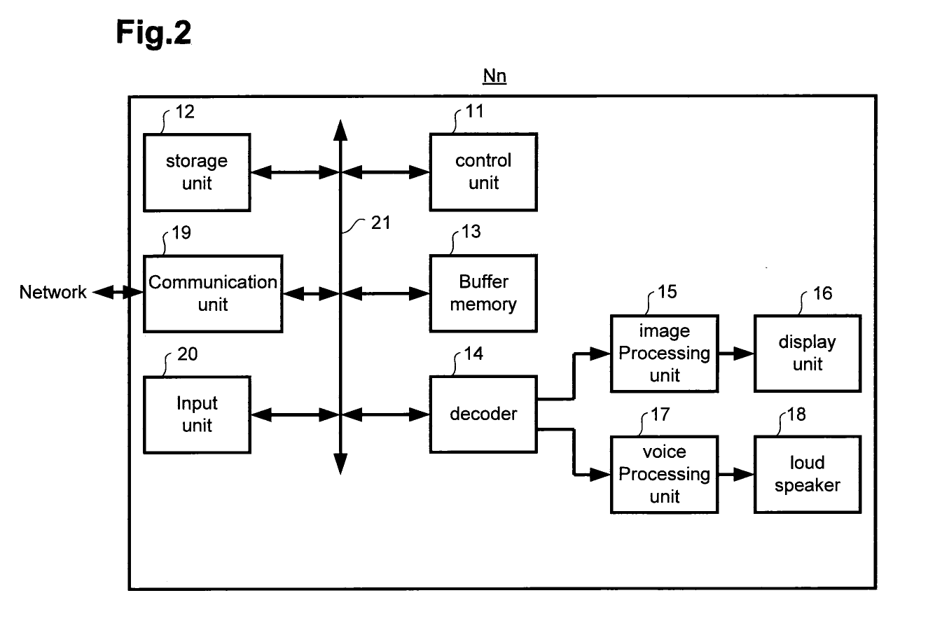

As illustrated in FIG. 2, the node includes a control unit 11 in the form of a computer, which is constituted by a CPU having a computing function, a working RAM, a ROM storing various data and programs, etc. Further, the node includes a storage unit 12 constituted by, e.g., a HD (hard disk) storing various data and programs, etc., and a buffer memory 13 temporarily accumulating received contents, etc. Still further, the node includes a decoder 14 for decoding, for example, video data or image information and audio data or voice information, which are encoded and included in contents. Still further, the node includes an image processing unit 15 for executing a predetermined drawing process on, e.g., decoded video data and outputting a video signal, and a display unit 16, such as a CRT or a liquid crystal display, for displaying an image in accordance with the video signal output from the image processing unit 15. Still further, the node includes a voice processing unit 17 for executing D (Digital)/A (Analog) conversion of decoded audio data to an analog audio signal, amplifying the analog audio signal by an amplifier, and outputting the amplified audio signal, and a loudspeaker 18 for outputting, as sound waves, the audio signal output from the voice processing unit 17. Still further, the node includes a communication unit 19 for controlling communication of information with respect to the center server SA and other nodes via the network 5. Still further, the node includes an input unit 20 for accepting an instruction from a user and providing an instruction signal corresponding to the accepted instruction to the control unit 11. The input unit 20 is, for example, a keyboard, a mouse, a remote controller, or an operating panel. The control unit 11, the storage unit 12, the buffer memory 13, the decoder 14, the communication unit 19, and the input unit 20 are interconnected via a bus 21.

In the case of the relay node, the node configuration may include the router RT. Stated another way, the relay node may have the function of the router RT in the LAN to which the relay node is connected.

The storage unit 12 stores the routing table using the DHT and the index information. Further, the storage unit 12 stores the address information of the contact node that serves as the access destination when the relevant node Nn participates into the content distributed storage system S. Still further, the storage unit 12 stores the address information of the center server SA, etc.

Moreover, the storage unit 12 stores the node ID of the node itself. In addition, the storage unit 12 stores the address information of the node itself. The address information of the non-relay node connected to the LAN is given as in-LAN address information. The in-LAN address information means address information that is used to transmit and receive messages within the LAN. The in-LAN IP address is a private IP address assigned within the LAN.

The address information of the non-relay node connected to the WAN 4 is given as in-WAN address information. The in-WAN address information means address information that is used to transmit and receive messages within the WAN 4. The in-WAN IP address is a global IP address assigned within the WAN 4.

For the relay node, LAN-side address information and WAN-side address information are stored as the address information in the storage unit 12. The LAN-side address information is in-LAN address information. The WAN-side address information is in-WAN address information when the network to which the router RT within the LAN is to be connected is the WAN 4. On the other hand, when the network to which the router RT within the LAN is to be connected is another LAN, in-LAN address information in the other LAN is stored in an area where the WAN-side address information is to be stored. In any case, the WAN-side IP address is the global IP address of the router RT within the LAN. Further, a WAN-side port number is the port number of the router RT within the LAN. When the relay node transmits and receives messages to and from the ex-LAN node through the NAT traversal, the relay node employs one or plural ports. Stated another way, the router RT is set so as to open one or plural ports that are used by the relay node to transmit and receive messages to and from the ex-LAN node. The LAN-side address information is one example of the private address information. Also, the WAN-side address information is one example of the global address information.

The LAN-side IP address is set, for example, by the user. Alternatively, the LAN-side IP address is assigned by the router RT within the LAN and is notified to the node from the router RT. The LAN-side port number is automatically set by the control unit 11, for example, in the initial setup of P2P software. The WAN-side IP address and port number are set by the user, for example, when static port-forwarding is employed. Also, when the UPnP (Universal Plug and Play) function of a broadband router is employed, the WAN-side IP address and port number are assigned by the router RT within the LAN and are notified to the node from the router RT. Further, when an NAT traversal technique using a server, such as STUN (Simple Traversal of UDP through NATs), is employed, the WAN-side IP address and port number are assigned by the router RT within the LAN and are notified to the node from the server, by way of example.

Still further, the storage unit 12 stores various programs including an operating system, P2P software, etc. As the P2P software, software for the non-relay node is stored in the non-relay node. Also, software for the relay node is stored in the relay node. Alternatively, the P2P software may be the same in both the non-relay node and the relay node. In this case, whether the relevant node is the non-relay node or the relay node is set by the user in initial setup of the P2P software. Then, programming of the P2P software is executed such that processing details of the control unit 11 is changed corresponding to the set information. Those various programs may be downloaded from the center server SA, for example. As another example, those various programs may be recorded on a recording medium and may be read into the storage unit 12 from the recording medium through a drive.

The control unit 11 supervises and controls the entirety of the node with the CPU reading and executing the programs stored in the storage unit 12, etc. Also, in the relay node, the control unit 11 functions as acquisition unit, relay unit, first determination unit, second determination unit, third determination unit, fourth determination unit, fifth determination unit, and sixth determination unit in the present invention with the CPU reading and executing the programs stored in the storage unit 12, etc. Further, in the non-relay node, the control unit 11 functions as transmission unit in the present invention with the CPU reading and executing the programs stored in the storage unit 12, etc.

### [3. Relay of Message]

A message relay method by the relay node will be described below.

### [3.1 Types of Node Information Contained in Message]

Each of messages transmitted and received among the nodes in the content distributed storage system S contains one or more sets of node information. The node information is, for example, information of the node as the destination of the message. As another example, the node information is information of the node as the transmission source of the message. The node information to be contained in the message depends on the type of the message. The relay node changes the node information contained in the message and relays the changed message. Typical examples of the message include the participation message, the participation response message, the search request message, the content transmission request message, the content transmission message, and the publish message as described above.

Each of the above-mentioned messages basically contains the node information representing the transmission source of the message, and the node information representing the transmission destination of the message. Depending on the type of the message, the node information representing the transmission source of the message may not be contained in the message. Herein, the node information representing the transmission source is called “source node information”, and the node information representing the transmission destination is called “destination node information”.

In the content distributed storage system S of this embodiment, some messages may contain not only the destination node information and the source node information, but, also additional node information that is added to the message. For example, when the message is transmitted with the addition of a content holding list in which the content holding nodes are listed, the additional node information is the node information included in the content holding list. As another example, when the publish message is transmitted with inclusion of the node information of the content holding node that stores the content, the additional node information is the node information of the content holding node. Further, the search request message contains, as the source node information, the node information of the user node. Also, the content transmission request message contains, as the additional node information, the node information of the user node. The node information of the user node as the source node information or the additional node information, is called “user node information”. The address information included in the source node information or the additional node information is one example of the address information that is added to the message other than the message destination.

### [3.2 Address List Included in Node Information]

The node information includes at least the node ID and an address list containing one or plural items of address information. One or plural items of address information contained in the address list may be assigned with respective numbers, such as address information 1, address information 2, address information 3, and so on. As described above, the address information is a set of the IP address and the port number. The node information includes, as most basic items, the node ID of the node, e.g., at the destination or the source and the address information of the node, e.g., at the destination or the source. When the address list contains one or plural items of address information except the address information of the destination or source, this implies that the address information of the relay node is added. For example, when the address list contains three items of address information, the address information 1 and the address information 2 represent respective data of the address information of two relay nodes. The address information 3 represents the node information corresponding to the node ID. And the address information 3 also represents the address information of the node, e.g., at the original destination or source. Further, the address information having a smaller number indicates that the address information is added at a later timing. For example, when the address list contains three items of the address information, the address information 1 is address information that is added later than the address information 2. Moreover, a number of address information represents an order of transmission of the message by nodes. For example, the address information and the information representing the above-mentioned order are set in the address list in a correspondence manner. As another example, the address list is provided as an array capable of containing plural items of address information. In the latter case, the order of transmission of message by nodes may be set as an index for the array. The address information 1 that is first in the order of the nodes is referred to as “head address information”. Each of the destination node information, the source node information, and the additional node information includes the node ID and the address list described above. Consider the case where the node having received one of the described above messages as a first message and, transmits a response message as a second message. In this case, the node having received the first message transmits the second message in response to the first message. The node having received the first message generates the second message which contains the source node information or the additional node information contained in the first message as the destination node information of the second message. As a result, the node having transmitted the first message can receive the second message. For example, the content holding node received the content transmission request message generates and transmits the content transmission request message which contains the user node information contained in the received content transmission request message.

### [3.3 Function of Relay Node]

The relay node relays a message from the in-LAN side to the ex-LAN side or from the ex-LAN side to the in-LAN side in some cases. In such cases, the address information of the relay node itself is added to the source node information and the additional node information, which are contained in the message. Thus, when the node having received the relayed first message sends a reply, as described above, the source node information or the additional node information, which is contained in the first message, is caused to be contained in the second message as the destination node information of the second message. Further, the node having received the relayed first message transmits the second message to the node corresponding to the head address information that is included in the destination node information. Accordingly, the second message is surely transmitted to the relay node. The head address information contained in the message received by the node, is always the address information of the node itself, which has received the message. In consideration of the above point, the node having received the message deletes the head address information from the destination node information of the received message. Such a deletion process is similarly executed in the relay node as well. After the head address information is deleted from the destination node information in the second message to be relayed, the address information of the node having transmitted the first message to the relay node is set as the head address information in the destination node information.

More specifically, the destination node information can include the address information of each of plural nodes. The address information is added to the destination node information when the first message is delivered or transmitted to another network via the relay node. The first message transmitted to the other network finally reaches the destination node. Then, the destination node transmits, as a reply, the second message. At that time, the destination node information in the second message includes two items of address information, i.e., the address information of the relay node and the address information of the node that is the original transmission source of the first message. Of those two items of address information, the added address information of the relay node is positioned at the head. Therefore, the node determines that the transmission source of the first message is the relay node, and the node is going to transmit the reply message to the relay node. Further, the relay node deletes the address information of the relay node itself from the destination node information in the second message and relays the message to the node that is the original transmission source. Thus, as a result of the relay node relaying the second message based on the head address information, the node having transmitted the first message to the relay node receives the second message.

As described above, the relay node supports to relay a message from the ex-LAN node through the relay of the message. Therefore, the node that is incapable of making the NAT transversal can transmit and receive messages to and from the in-LAN side. Processes executed when the relay node relays the message will be described below.

In the case of relay from the in-LAN side to the ex-LAN side:

(1-1) The relay node adds the WAN-side address information of the relay node to the address list in the source node information or the additional node information.
(1-2) However, when the LAN-side address information of the relay node is set in the address list in the source node information or the additional node information, the LAN-side address information is deleted from the address list in the source node information or the additional node information, and the WAN-side address information of the relay node is not added.

In the case of relay from the ex-LAN side to the in-LAN side:

(2-1) The relay node adds the LAN-side address information of the relay node to the address list in the source node information or the additional node information.
(2-2) However, when the WAN-side address information of the relay node is set in the address list in the source node information or the additional node information, the WAN-side address information is deleted from the address list in the source node information or the additional node information, and the LAN-side address information of the relay node is not added.

In the above examples (1-1) and (2-1), the address information used in the network to which the message is to be relayed is added to the source node information or the additional node information.

The above examples (1-2) and (2-2) represent a process for reducing the number of relays of useless messages. The process of reducing is executed by the relay node. For example, a message relayed from the ex-LAN side to the in-LAN side is relayed again to the ex-LAN side in some cases. In such a case, when the message is relayed for the first time, the LAN-side address information of the relay node is added to the source node information or the additional node information. Further, when the message is relayed for the second time, the WAN-side address information of the relay node is added to the source node information or the additional node information. On those conditions, the WAN-side address information of the relay node and the LAN-side address information of the relay node are set in the address list in the source node information or the additional node information that is contained in the relayed message. Further, the address information of the ex-LAN node transmitted the message to the relay node is set in the relevant address list. The thus-prepared node information is provided as the destination node information for a message replied in response to the relayed message. Therefore, when the message is transmitted in accordance with that destination node information, the message is relayed by the relay node two times more. However, the relevant message is a message that may be directly transmitted from the one ex-LAN node to the other ex-LAN node. In view of this, it is expedient to change the source node information or the additional node information by the relay node such that the message is directly transmitted from the one ex-LAN node to the other ex-LAN node. Stated another way, if the address information of the relay node is deleted from the source node information or the additional node information when the message is relayed for the second time, the head address information of the source node information or the additional node information is set to the address information of the ex-LAN node having transmitted the message to the relay node. Further, the address information of the relevant ex-LAN node is set as the head address information in the destination node information that is contained in the reply message in response to the relayed message. Consequently, when the message is transmitted in accordance with the relevant address information, the message is directly transmitted from the one ex-LAN node to the other ex-LAN node.

An example of a process for participation in the overlay network is described below. When the relay node transmits a participation response message to the in-LAN node, the relay node sets the LAN-side address information of the relevant relay node as the address information in the source node information or the additional node information. On the other hand, when the relay node transmits the participation response message to the ex-LAN node, the relay node sets the WAN-side address information of the relevant relay node as the address information in the source node information or the additional node information, the participating node sets, in the routing table, the source node information or the additional node information that is contained in the received participation response message. As a result, the routing table is prepared. Let us now consider, for example, the case where the node newly participates in the content distributed storage system S and newly participating node transmits the participation message to a certain node, which is connected to one network.

The one network is different from a network to which the newly participation node connects. The certain node replies the participation response message, and the participation response message is relayed by the relay node. Accordingly, the address information of the relay node is added to the source node information or the additional node information that is contained in the participation response message received by the participating node.

When the relay node participates in the content distributed storage system S, the relay node transmits the participation message to each of the in-LAN contact node and the ex-LAN contact node for which the relevant relay node relays messages. Further, the relay node receives the participation response messages from both the in-LAN and ex-LAN contact nodes and prepares the routing table. In case of the index information when the content holding node transmits the publish message, the content holding node causes, as the source node information or the additional node information, the node information of the content holding node itself to be contained in the publish message. The root node having received the publish message adds the source node information or the additional node information to the index information. The added source node information or the additional information is contained in the publish message. When the publish message is relayed by the relay node, the address information of the relay node is added to the source node information or the additional node information that is contained in the publish message.

As described above, when a relay of the message by the relay node is required, the address information of the relay node is added to the node information set in the routing table or the index information, which is stored in each node. Accordingly, when each node transmits, transfers, or replies to the message, the node is not required to determine whether the relevant message needs the relay or not. Each node is just required to transmit the message to the node indicated by the head address information in the source node information that is contained in the message. Following the transmission of the message, the relay node relays the relevant message as required.

The non-relay node does not execute processing on judgment as to whether another node is a relay node or a non-relay node. Also, the non-relay node operates in the same manner on any type of node. Thus, the non-relay node acquires the address information of the relay node through various communication processes as in the case of acquiring the address information of the non-relay node. For example, the address information of the relay node is notified to the non-relay node from the contact node.

### [3.4 Practical Example]

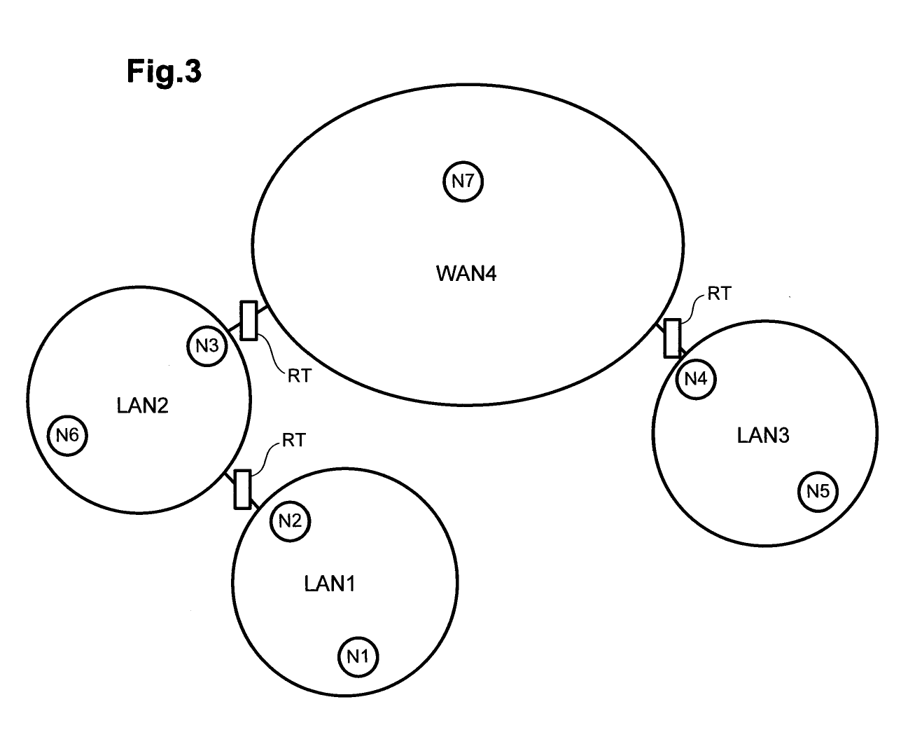

Operations related to the relay of the message by the relay node will be described below in connection with a practical example. As illustrated in FIG. 3, a LAN 1 and a LAN 2 are connected to each other through a router RT. A LAN 2 and a WAN 4 are connected to each other through a router RT. Further, a LAN 3 and the WAN 4 are connected to each other through a router RT. Nodes N1 and N2 are connected to the LAN 1. Nodes N3 and N6 are connected to the LAN 2. Nodes N4 and N5 are connected to the LAN 3. A node N7 is connected to the WAN 4. Here, the node N2 is a relay node for relaying a message between the LAN 1 and the LAN 2. The node N3 is a relay node for relaying a message between the LAN 2 and the WAN 2. Further, the node N4 is a relay node for relaying a message between the LAN 3 and the WAN 4.

Each of the nodes N2, N3 and N4 serving as the relay nodes has WAN-side address information and LAN-side address information. The LAN-side address information of the node N2 is address information on the LAN 1 side, and the WAN-side address information of the node N2 is address information on the LAN 2 side. The LAN-side address information of the node N3 is address information on the LAN 2 side, and the WAN-side address information of the node N3 is address information on the WAN 4 side. Further, the LAN-side address information of the node N4 is address information on the LAN 3 side, and the WAN-side address information of the node N4 is address information on the WAN 4 side.

Let now consider, for example, the case where the node N4 relays a message from the node N7 to the node N5. In this case, the message from the node N7 to the node N5 is a message from the WAN 4 to the LAN 3. The node N4 adds the LAN-side address information of the node N4 to the source node information or the additional node information that is contained in the relayed message. Further, when the node N4 relays a message from the LAN 3 to the WAN 4, the node N4 adds the WAN-side address information of the node N4 to the source node information or the additional node information that is contained in the relayed message.

However, when the node N4 relays, to the WAN 4, the message that once was relayed from the WAN 4 to the LAN 3, the node N4 deletes the LAN-side address information of the node N4 from the source node information or the additional node information that is contained in the relayed message. Also, when the node N4 relays, to the LAN 3, the message that has been once relayed from the LAN 3 to the WAN 4, the node N4 deletes the WAN-side address information of the node N4 from the source node information or the additional node information that is contained in the relayed message.

As another example, a message from the node N1 to the node N5, i.e., a message from the LAN 1 to the LAN 3, is relayed by the relay nodes in the order of the node N2, the node N3, and the node N4. On that occasion, the WAN-side address information of the node N2, the WAN-side address information of the node N3, and the LAN-side address information of the node N4 are successively added to the source node information or the additional node information that is contained in the relayed message. As still another example, a message from the LAN 3 to the LAN 1 is relayed by the relay nodes in the order of the node N4, the node N3, and the node N2. On that occasion, the WAN-side address information of the node N4, the LAN-side address information of the node N3, and the LAN-side address information of the node N2 are successively added to the source node information or the additional node information that is contained in the relayed message.

However, when the message once relayed from the LAN 1 to the LAN 3 is relayed back to the LAN 1, the LAN-side address information of the node N4, the WAN-side address information of the node N3, and the WAN-side address information of the node N2 are successively deleted from the source node information or the additional node information that is contained in the relayed message. Also, when the message once relayed from the LAN 3 to the LAN 1 is related back to the LAN 3, the LAN-side address information of the node N2, the LAN-side address information of the node N3, and the WAN-side address information of the node N4 are successively deleted from the source node information or the additional node information that is contained in the relayed message.

### [4. Operation of Content Distributed Storage System]

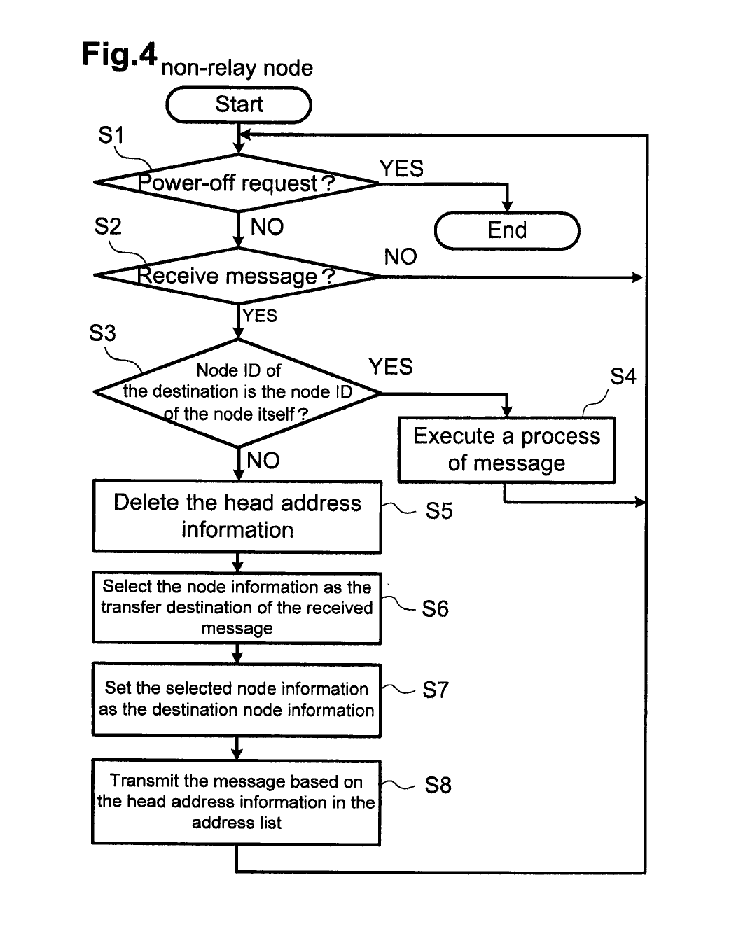

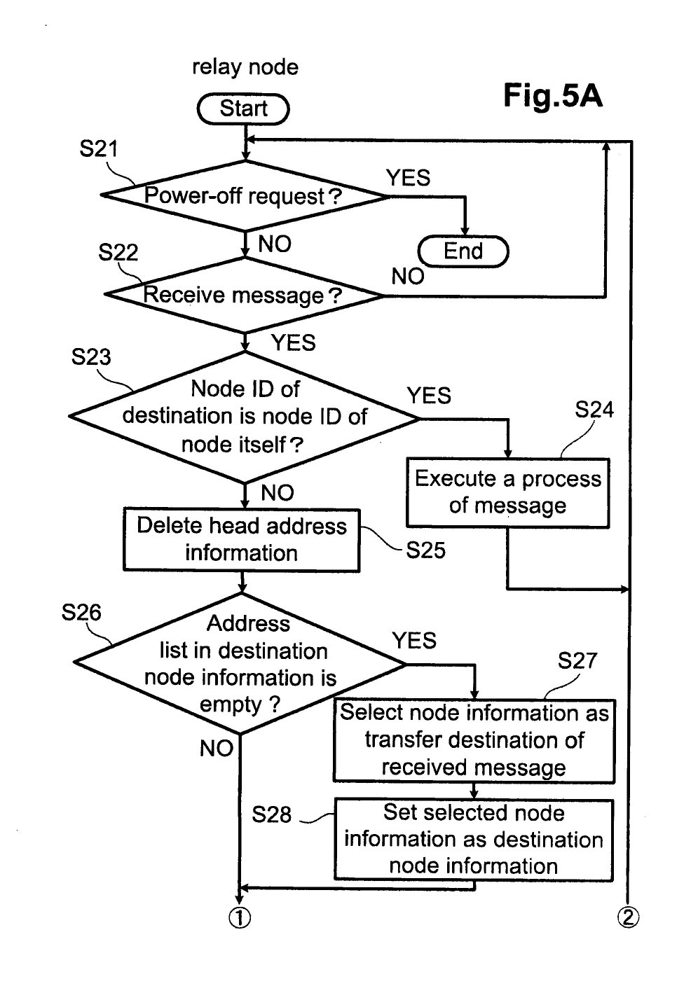

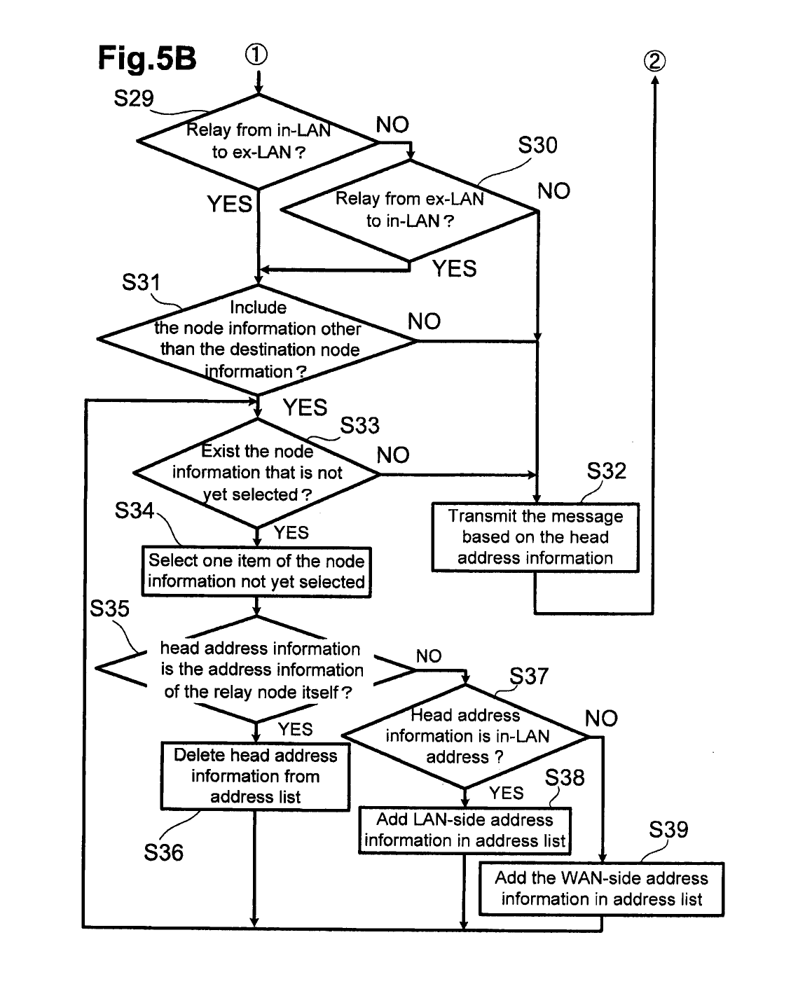

The operation of the content distributed storage system S according to this embodiment will be described below with reference to FIGS. 4 and 5.

Processing illustrated in FIG. 4 is started, for example, upon turning-on of a power supply for the non-relay node. First, the control unit 11 determines whether a power-off request is inputted from a user (step S1). If the power-off request is not inputted from the user (step S1: NO), the control unit 11 determines whether a message is received from another node Nn (step S2). If a message is not received from another node (step S2: NO), the control unit 11 shifts to step S1.

On the other hand, if a message is received from another node (step S2: YES), the control unit 11 determines whether the node ID of the destination node information in the received message is the node ID of the node itself, which has received the relevant message (step S3). If the node ID of the destination node information in the received message is the node ID of the node itself, which has received the relevant message (step S3: YES), the control unit 11 shifts to step S4. Then, the control unit 11 executes a process corresponding to the received message (step S4). For example, when the received message is the search request message, the control unit 11 determines whether the node having received the message is itself the root node. If the node having received the message is itself the root node, the control unit 11 transmits the content transmission request message to the content holding node. On the other hand, if the node having received the message is not the root node, the control unit 11 transfers the search request message in accordance with the routing table. As another example, when the received message is the content transmission request message, the control unit 11 transmits the content transmission message including the requested content. After completing the process of step S4, the control unit 11 shifts to step S1.

If it is determined in step S3 that the node ID of the destination node information in the received message is not the node ID of the node Nn itself, which has received the relevant message (step S3: NO), the control unit 11 transfers the received message. More specifically, the control unit 11 deletes the head address information from the address list in the destination node information that is contained in the received message (step S5). Then, the control unit 11 selects the node information, which indicates the transfer destination of the received message, based on the routing table stored in the storage unit 12 (step S6). Then, the control unit 11 sets the selected node information as the destination node information for the message to be transferred (step S7). In other words, the control unit 11 rewrites the destination node information. Then, the control unit 11 transmits the message based on the head address information in the address list that is included in the set destination node information (step S8). More specifically, the control unit 11 sets the IP address of the head address information to the destination address of an IP header of a message packet. Further, the control unit 11 sets the port number of the head address information to the destination port number of a UDP (User Datagram Protocol) header or a TCP (Transmission Control Protocol) header of the message packet. Then, the control unit 11 successively transmits the packets of which headers have been set. After completing the process of step S8, the control unit 11 shifts to step S1.

If it is determined in step S1 that the power-off request is inputted from the user (step S1: YES), the control unit 11 brings the processing illustrated in FIG. 4 to an end.

Processing illustrated in FIGS. 5A and 5B is started, for example, upon turning-on of a power supply for the relay node. First, the control unit 11 determines whether a power-off request is inputted from a user (step S21). If the power-off request is not inputted from the user (step S21: NO), the control unit 11 determines whether a message is received from another node (step S22). If a message is not received from another node (step S22: NO), the control unit 11 shifts to step S21.

On the other hand, if a message is received from another node (step S22: YES), the control unit 11 determines whether the node ID of the destination node information in the received message is the node ID of the node itself, which has received the relevant message (step S23). If the node ID of the destination node information in the received message is the node ID of the node itself, which has received the relevant message (step S23: YES), the control unit 11 executes a process corresponding to the received message (step S24). Details of the process executed in step S24 is similar to that executed in step S4 illustrated in FIG. 4. Then, the control unit 11 shifts to step S21.

If it is determined in step S23 that the node ID of the destination node information in the received message is not the node ID of the node itself (step S23: NO), the control unit 11 deletes the head address information from the address list in the destination node information that is contained in the received message (step S25). Then, the control unit 11 determines whether the address list in the destination node information contained in the received message is empty (step S26). If the address list in the destination node information contained in the received message is empty (step S26: YES), the control unit 11 executes a process of transferring the message. More specifically, the control unit 11 selects the node information, which indicates the transfer destination of the received message, based on the routing table stored in the storage unit 12 (step S27). Then, the control unit 11 sets the selected node information as the destination node information for the message to be transferred (step S28).

If it is determined in step S26 that the address list in the destination node information contained in the received message is not empty (step S26: NO), or after the process of step S28 has been completed, the control unit 11 determines, whether the received message is a message to be relayed from the in-LAN side to the ex-LAN side (step S29). For example, an IP address is made up of a network address for identifying a network, and a host address for identifying a host within the network. Therefore, the control unit 11 compares a network address portion of a transmission source address, which is set in the IP header of the received message, with a network address portion of the LAN-side IP address of the relay node itself, which is stored in the storage unit 12. If both the network addresses match with each other, this means that the received message is a message transmitted from the in-LAN side. And, if both the network addresses do not match with each other, this means that the received message is a message transmitted from the ex-LAN side. From the IP address, the class of the relevant IP address can be specified. Further, from the specified class, it is possible to make determination as to how many bits counting from the most significant bit of the IP address represent the network address. Alternatively, when a subnet mask is stored in the storage unit 12, it is possible, based on the subnet mask, to make a determination as to how many bits counting from the most significant bit of the IP address represent the network address and a subnet address. In the latter case, whether the network address and the subnet address match with each other is determined. Further, the control unit 11 compares the network address in the IP address of the head address information, which is contained in the address list in the destination node information, with the network address in the LAN-side IP address of the relay node itself, which is stored in the storage unit 12. If both the network addresses match with each other, this means that the received message is a message to be transmitted to the in-LAN side. And, if both the network addresses do not match with each other, this means that the received message is a message to be transmitted to the ex-LAN side.

If the received message is not the message to be relayed from the in-LAN side to the ex-LAN side (step S29: NO), the control unit 11 determines, whether the received message is a message to be relayed from the ex-LAN side to the in-LAN side (step S30). If the received message is not the message to be relayed from the ex-LAN side to the in-LAN side (step S30: NO), this means that the received message is a message to be simply transferred from one in-LAN node to another in-LAN node or one ex-LAN node to another ex-LAN node. In such a case, therefore, the control unit 11 transmits the message based on the head address information in the address list that is contained in the destination node information (step S32), and then shifts to step S1.

If the received message is a message to be relayed from the in-LAN side to the ex-LAN side (step S29: YES), or if the received message is a message to be relayed from the ex-LAN side to the in-LAN side (step S30: YES), the control unit 11 operates to relay the message.

More specifically, the control unit 11 determines whether the received message includes the node information other than the destination node information, i.e., at least one of the source node information and the additional node information (step S31). If the received message includes neither the source node information nor the additional node information (step S31: NO), the control unit 11 transmits the message in step S32, thereby relaying the message.

On the other hand, if the received message includes at least one of the source node information and the additional node information (step S31: YES), the control unit 11 determines whether the source node information or the additional node information includes the node information that is not yet selected (step S33). If there exists the node information not yet selected (step S33: YES), the control unit 11 selects one item of the node information not yet selected (step S34). Then, the control unit 11 determines, whether the head address information in the address list, which is included in the selected node information, is the address information of the relay node itself (step S35). More specifically, the control unit 11 compares the IP address in the head address information in the address list, which is included in the selected node information, with the LAN-side IP address and the WAN-side IP address of the relay node, which are stored in the storage unit 12. If the IP address in the head address information matches with either the LAN-side IP address or the WAN-side IP address of the relay node, this means that the head address information in the address list, which is contained in the selected node information, is the address information of the relay node itself. On the other hand, if the IP address in the head address information does not match with any of the LAN-side IP address and the WAN-side IP address of the relay node, this means that the head address information in the address list, which is contained in the selected node information, is not the address information of the relay node itself.

If the head address information in the address list, which is contained in the selected node information, is the address information of the relay node itself (step S35: YES), the control unit 11 deletes the head address information from the address list in the selected node information (step S36). After completing the process of step S36, the control unit 11 shifts to step S33.

If the head address information in the address list, which is contained in the selected node information, is not the address information of the relay node itself (step S35: NO), the control unit 11 determines whether the head address information in the address list, which is contained in the selected node information, is the address information of any in-LAN node (step S37). If the control unit 11 determines that the head address information in the address list, which is contained in the selected node information, is the address information of any in-LAN node (step S37: YES), the control unit 11 acquires the LAN-side address information of the relay node itself, which is stored in the storage unit 12. Further, the control unit 11 adds the acquired LAN-side address information to the address list in the selected node information (step S38). On the other hand, if the control unit 11 determines that the head address information in the address list, which is contained in the selected node information, is the address information of any ex-LAN node (step S37: NO), the control unit 11 acquires the WAN-side address information of the relay node itself, which is stored in the storage unit 12. Further, the control unit 11 adds the acquired WAN-side address information to the address list in the selected node information (step S39). After completing the process of step S38 or S39, the control unit 11 shifts to step S33.

If it is determined in step S33 that neither the source node information nor the additional node information includes the node information that is not yet selected (step S33: NO), the control unit 11 transmits the message in step S32, thereby relaying the message.

If it is determined in step S21 that the power-off request is input from the user (step S21: YES), the control unit 11 brings the processing illustrated in FIGS. 5A and 5B to an end.

According to this embodiment, as described above, when a message is relayed from the in-LAN side to the ex-LAN side, the control unit 11 of the relay node causes the acquired WAN-side address information to be included in the relevant message, and when a message is relayed from the ex-LAN side to the in-LAN side, the control unit 11 causes the acquired LAN-side address information to be included in the relevant message. Accordingly, the node Nn having received the message from the relay node can transmit a message to the relay node based on the address information contained in the received message. Further, the relay node can relay the message to the ex-LAN side or the in-LAN side. Thus, since messages are transmitted and received between the in-LAN side and the ex-LAN side through the relay node, the processing load for the address resolution can be reduced.

Moreover, the control unit 11 of the relay node executes transmission and reception of messages to and from the ex-LAN side through the router RT by using a predetermined number of ports, which are assigned to the relay node, among a plurality of WAN-side ports in the router RT. In the router RT, therefore, the ports necessary for the relay node to execute communication with the ex-LAN side are opened. With those ports being opened, the in-LAN node and the ex-LAN node can transmit and receive messages therebetween through the relay node. Thus, because of no need of opening the port for each node Nn, safety against, e.g., fraudulent communication from the ex-LAN side can be enhanced. In addition, a table necessary for the address translation can be prevented from being filled in the router RT.

Alternatively, the control unit 11 of the relay node may execute transmission and reception of messages to and from the ex-LAN side through the router RT by using one predetermined WAN-side port that is assigned in the router RT for the relay node. In that case, since only one port needs to be opened in the router RT for the relay node, the safety can be further enhanced.

Further, when a message is relayed from the in-LAN side to the ex-LAN side, the control unit 11 of the relay node causes the WAN-side address information of the relay node to be contained in the message as the source node information or the additional node information therein. Accordingly, the ex-LAN/node having received the message from the relay node can transmit a message by setting, as the address information in the destination node information in the message to be transmitted, the address information in the source node information or the additional node information that is contained in the received message. As a result, the relevant message is transmitted to the relay node. Then, the relay node can relay the relevant message to the in-LAN side.

In addition, when a message is relayed from the in-LAN side to the ex-LAN side, the control unit 11 of the relay node adds the WAN-side address information of the relay node to the address list in the source node information or the additional node information that is contained in the relevant message. Accordingly, the ex-LAN node having received the message from the relay node can transmit a message by setting, as the address information in the destination node information in the message to be transmitted, the address information in the source node information or the additional node information that is contained in the received message. As a result, the relevant message is transmitted to the relay node. Then, the relay node can relay the relevant message to the in-LAN side.

The control unit 11 of the relay node determines whether the message to be relayed is a message transmitted from the ex-LAN side to the in-LAN side. If it is determined that the message to be relayed is a message transmitted from the ex-LAN side to the in-LAN side, the control unit 11 of the relay node deletes the WAN-side address information of the relay node from the address list in the source node information or the additional node information that is contained in the message. Accordingly, when the in-LAN node Nn having received the message from the relay node replies a message, the reply message is not relayed by the relay node and is transmitted and received between the in-LAN nodes. As a result, a relay load of the relay node can be reduced.

Also, when a message is relayed from the in-LAN side to the ex-LAN side, the control unit 11 of the relay node determines whether the LAN-side address information of the relay node is contained in the message. If it is determined that the LAN-side address information of the relay node is not contained in the message, the control unit 11 of the relay node adds the WAN-side address information of the relay node to the message, and if it is determined that the LAN-side address information of the relay node is contained in the message, the control unit 11 deletes the LAN-side address information of the relay node from the message. Accordingly, when the message is relayed from the in-LAN side to the ex-LAN side, addition or deletion of the address information of the relay node can be properly executed.

In the flowchart of FIGS. 5A and 5B, the processing of steps S33 to S39 is executed on condition that plural items of the source node information or the additional node information are contained in the message. Therefore, the message may contain plural items of the source node information or the additional node information. In the embodiment described above, the root node selects the content holding node from which the content is to be transmitted, and then transmits the content transmission request message to the selected content holding node. As another example, however, the root node may select the node information of plural content holding nodes from the index information, and may transmit, to the user node, the search response message that contains the selected plural sets of node information in the source node information or the additional node information therein. In such a modified case, the user node selects arbitrary one set of node information from the source node information or the additional node information that is contained in the received search response message, and then requests the content to the content holding node based on the selected node information. On that occasion, the relay node executes, as described above in connection with FIGS. 5A and 5B, addition or deletion of the address information of the relay node for each set of the source node information or the additional node information that is contained in the received search response message.

In the embodiment described above, when the relay node relays the message, the relay node adds the address information of the relay node to the source node information or the additional node information. However, the relay node may rewrite the address information in the source node information or the additional node information to the address information of the relay node by storing a table for translation of the address information. In such a modified case, for example, when the message to be relayed is received, the relay node generates identification information and stores the address information in the source node information or the additional node information in the message and the identification information in a table in a correspondence relation. Further, the relay node rewrites the source node information or the additional node information in the message to the address information of the relay node. Still further, the relay node adds the generated identification information to the source node information or the additional node information in the message. The relay node then relays the message. Thereafter, if, at the time of receiving a message to be relayed, the identification information is included in the destination node information contained in the message, the relay node determines whether the relevant identification information and the identification information stored in the table match with each other. If both data of the identification information match with each other, the relay node acquires the address information corresponding to the identification information from the table. After rewriting the address information in the destination node information contained in the message to the acquired address information, the relay node relays the message.

While there are plural LANs in the embodiment described above, the number of LANs may be one. Also, there may present a plurality of WANs.

While the Peer to Peer network utilizing the DHT is applied to the overlay network in the embodiment described above, the present invention is not limited to that type of network. For example, the present invention may be applied to other types of Peer to Peer systems or other systems using overlay networks. One example of the Peer to Peer system not utilizing the DHT is a hybrid-type Peer to Peer system.

What is claimed is:

1. An information communication system in which a plurality of node devices transmit and receive a message with respect to one another via a network including at least one private network,
the information communication system including, among the plurality of node devices, a relay node device which is connected to the private network and which relays the messages between the private network and an external network differing from the private network,
wherein the relay node device comprises:
an acquisition unit configured to acquire, as address information of the relay node device, private address information representing address information in the private network and global address information representing address information in the external network; and
a relay unit configured to relay the message after causing the global address information acquired by the acquisition unit to be contained in the message in response to relaying the message from the private network to the external network, and to relay the message after causing the private address information acquired by the acquisition unit to be contained in the message in response to relaying the message from the external network to the private network which is connected to the external network, and
wherein the node device connected to the private network comprises:
a transmission unit configured to transmit a message, which is destined for the node device connected to the external network, through the relay node device.

2. The information communication system according to claim 1, further including a communication device for interconnecting the private network and the external network,
wherein the relay unit of the relay node device is configured to execute transmission and reception of a message to and from the external network through the communication device by using a predetermined number of ports, which are assigned to the relay node device, among a plurality of ports prepared in the communication device on the external network side thereof.

3. The information communication system according to claim 2,
wherein the relay unit of the relay node device executes transmission and reception of a message to and from the external network through the communication device by using one predetermined port, which is assigned to the relay node device in the communication device on the external network side thereof.

4. A relay node device disposed in an information communication system, in which a plurality of node devices transmit and receive messages with respect to one another via a network including at least one private network, to serve as one of the node devices to relay the messages,
the information communication system including, among the plurality of node devices, the relay node device which is connected to the private network and which relays a message between the private network and an external network differing from the private network,
wherein the relay node device comprises:
an acquisition unit configured to acquire as address information of the relay node device, private address information representing address information in the private network and global address information representing address information in the external network; and
a relay unit configured to relay the message after causing the global address information acquired by the acquisition unit to be contained in the message in response to relaying the message from the private network to the external network,
and to relay the message after causing the private address information acquired by the acquisition unit to be contained in the message in response to relaying the message from the external network to the private network which is connected to the external network.

5. The relay node device according to claim 4,
wherein the information communication system further includes a communication device for interconnecting the private network and the external network, and
wherein the relay unit is configured to execute transmission and reception of the message to and from the external network through the communication device by using a predetermined number of ports, which are assigned to the relay node device, among a plurality of ports prepared in the communication device on the external network side thereof.

6. The relay node device according to claim 5,
wherein the relay unit executes transmission and reception of the message to and from the external network through the communication device by using one predetermined port, which is assigned to the relay node device in the communication device on the external network side thereof.

7. The relay node device according to claim 4,
wherein the message contains address information of the node device indicated by a destination of the message and address information of the node device differing from the node device indicated by the destination, and
wherein in response to relaying the message from the private network to the external network, the relay unit causes, as the address information contained in the message, the global address information of the relay node device to be contained the message.

8. The relay node device according to claim 7,
wherein the message contains one or more items of address information, and
wherein in response to relaying the message from the private network to the external network, the relay unit adds the global address information of the relay node device to the address information contained in the message.

9. The relay node device according to claim 7, further comprising:
a first determination unit configured to determine whether the message relayed by the relay unit is a message transmitted from the private network to the external network,
wherein in response to a determination that the relayed message is a message transmitted from the private network to the external network by the first determination unit, the relay unit causes the global address information of the relay node device to be contained in the message.

10. The relay node device according to claim 7, further comprising:
a second determination unit configured to determine whether the message relayed by the relay unit is a message transmitted from the external network to the private network,
wherein in response to determine that the relayed message is a message transmitted from the external network to the private network by the second determination unit, the relay unit deletes the global address information of the relay node device from the address information contained in the message.

11. The relay node device according to claim 7, wherein the relay unit further comprises:
a third determination unit configured to, in response to relaying the message from the private network to the external network, determine whether the private address information of the relay node device is contained in the message,
wherein in response to a determination that the private address information of the relay node device is not contained in the message by the third determination unit, the relay unit add the global address information of the relay node device to the message, and
wherein in response to determine that the private address information of the relay node device is contained in the message by the third determination unit, the relay unit deletes the private address information of the relay node device from the message.

12. The relay node device according to claim 4, wherein the message contains address information of the node device indicated by a destination of the message and address information of the node device differing from the node device indicated by the destination, and
wherein in response to relaying the message from the external network to the private network, the relay unit causes, as the address information added to the message, the private address information of the relay node device to be contained in the message.

13. The relay node device according to claim 12, wherein the message contains one or more items of address information, and
wherein in response to relaying the message from the external network to the private network, the relay unit adds the private address information of the relay node device to the address information contained in the message.

14. The relay node device according to claim 12, further comprising:
a fourth determination unit configured to determine whether the message relayed by the relay unit is a message transmitted from the external network to the private network,
wherein in response to a determination that the relayed message is a message transmitted from the external network to the private network by the fourth determination unit, the relay unit causes the private address information of the relay node device to be contained in the message.

15. The relay node device according to claim 12, further comprising:
a fifth determination unit configured to determine whether the message relayed by the relay unit is a message transmitted from the private network to the external network,
wherein in response to determining that the relayed message is a message transmitted from the private network to the external network by the fifth determination unit, the relay unit is configured to delete the private address information of the relay node device from the address information contained in the message.

16. The relay node device according to claim 12, wherein the relay unit further comprises:
a sixth determination unit configured to, in response to relaying the message from the external network to the private network, determine whether the global address information of the relay node device is contained in the message,
wherein in response to determining that the global address information of the relay node device is not contained in the message by the sixth determination unit, the relay unit is configured to add the private address information of the relay node device to the message, and
wherein in response to determining that the global address information of the relay node device is contained in the message by the sixth determination unit, the relay unit is configured to delete the global address information of the relay node device from the message.

17. An information communication method for a relay node device that is disposed in an information communication system, in which a plurality of node devices transmit and receive messages with respect to one another via a network including at least one private network, to serve as one of the node devices to relay the messages,
the information communication system including, among the plurality of node devices, the relay node device which is connected to the private network and which relays the messages between the private network and an external network differing from the private network,
wherein the information communication method comprises:
acquiring, as address information of the relay node device, private address information representing address information in the private network and global address information representing address information in the external network by the relay node device; and
relaying the message after causing the global address information acquired in the aforementioned acquiring step to be contained in the message in response to the message from the private network to the external network, and relaying the message after causing the private address information acquired in the acquisition step to be contained in the message in response to relaying the message from the external network to the private network which is connected to the external network.

18. A non-transitory computer readable recording medium storing a program for operating a relay node device that is disposed in an information communication system, in which a plurality of node devices transmit and receive messages with respect to one another via a network including at leas: one private network, to serve as one of the node devices to relay the messages,
the information communication system including, among the plurality of node devices, the relay node device which is connected to the private network and which relays the messages between the private network and an external network differing from the private network,
said program causing a computer of the relay node device to execute:
acquiring, as address information of the relay node device, private address information representing address information in the private network and global address information representing address information in the external network; and
relaying the message after causing the global address information acquired in the acquiring to be contained in the message in response to relaying the message from the private network to the external network, and relaying the message after causing the private address information acquired in the acquiring to be contained in the message in response to relaying the message from the external network to the private network which is connected to the external network.
